(19) United States
(12) Patent Application Publication
(10) Pub. No.: US 2020/0082389 A1
(43) Pub. Date: Mar. 12, 2020

(54) PAYMENT SYSTEM FOR AUGMENTED, MIXED, OR VIRTUAL REALITY PLATFORMS INTEGRATED WITH CRYPTOCURRENCY WALLET

(71) Applicant: Jointer, Inc., Los Altos, CA (US)

(72) Inventor: Yehuda Gavrielov REGEV, Los Altos, CA (US)

(73) Assignee: Jointer, Inc., Los Altos, CA (US)

(21) Appl. No.: 16/564,418

(22) Filed: Sep. 9, 2019

Related U.S. Application Data
(60) Provisional application No. 62/728,183, filed on Sep. 7, 2018.

(51) Int. Cl. G06Q 20/36; G06Q 20/38; G06Q 20/06; G06F 3/0482; G06F 3/0486

(52) U.S. Cl. CPC G06Q 20/3678; G06Q 20/389; G06Q 20/0658; G06Q 20/042; G06F 3/0486; G06Q 2220/00; G06F 3/0482

(57) ABSTRACT

The invention relates to an improved electronic reality system (e.g., augmented reality, mixed reality, and/or or virtual reality system) that integrates a cryptocurrency wallet for transmitting funds between senders and recipients based on interactions made in the electronic reality system, such as a drag and drop interaction in which an image of an item to be purchased or representation of funds to be transferred is dragged and dropped to an image of the cryptocurrency wallet in an AR display.

### CROSS-REFERENCE TO RELATED APPLICATIONS

This application claims priority to U.S. Provisional Patent Application Ser. No. 62/728,183, entitled “PAYMENT SYSTEM FOR AUGMENTED, MIXED, OR VIRTUAL REALITY PLATFORMS INTEGRATED WITH CRYPTOCURRENCY WALLET”, filed Sep. 7, 2018, which is hereby incorporated by reference in its entirety.

### FIELD OF THE INVENTION

The invention relates to an improved electronic reality system (e.g., augmented reality, mixed reality, and/or or virtual reality system) that integrates a cryptocurrency wallet for transmitting funds between senders and recipients based on interactions made in the electronic reality system, such as a drag and drop interaction in which an image of an item to be purchased or representation of funds to be transferred is dragged and dropped to an image of the cryptocurrency wallet in an AR display.

### BACKGROUND OF THE INVENTION

Electronic reality systems such as Argument Reality (“AR”), Mixed Reality (“MR”), and Virtual Reality (“VR”) are becoming increasingly widespread as technology for implementing them improves.

AR relates to a computer-based system that overlays data on top of a physical environment, while enabling the user to continue to view the physical environment. For instance, some AR systems may recognize physical objects or markers placed in the physical environment, map them to an overlay space coincident with the physical environment, and overlay data on the recognized object or marker. MR is a form of augmented reality that augments the physical environment with virtual objects that appear to be part of the physical environment. Unlike AR and MR systems, VR systems replace the physical environment with a completely virtual one in which objects are computer generated. The intent of VR systems is to immerse the user into an artificial or virtual world separate from the physical environment.

The utility of these systems is growing as content and services expands and the technology matures. However, these systems lack a secure and immutable way to transfer funds in connection with using the technology. Thus, transactions made using these systems may be vulnerable to malicious attacks or even passive threats such as leaving payment information unprotected. These and other drawbacks exist for conventional AR, MR, and VR systems.

### SUMMARY OF THE INVENTION

One aspect of the invention relates to an improved AR system that integrates a cryptocurrency wallet for transmitting funds between senders and recipients based on interactions made using the AR system, such as a drag and drop interaction in which an image representing an item to be purchased or funds to be transferred is dragged and dropped to an image that represents the cryptocurrency wallet in an AR display. The image representing the item or funds may include a likeness (including a photograph) of the item and/or may be a graphical/textual indicator such as a tag to indicate that the item is draggable. When the image representing an item is dropped to the image representing the cryptocurrency wallet (“wallet image”) in the AR display, the AR system may initiate a blockchain transaction that transfers funds from the cryptocurrency wallet to a seller's cryptocurrency wallet. Likewise, when an image representing a fund transfer (e.g., a virtual check) is dropped to the image representing the cryptocurrency wallet in the AR display, the AR system may initiate a blockchain transaction that transfers funds from the cryptocurrency wallet to a recipient's cryptocurrency wallet.

To facilitate the foregoing, the AR system may include an AR device that may be—though is not necessarily—head-mounted, a peripheral device for pointing and other interactions, an AR processing unit that processes sensor information from the AR device and/or the peripheral device and provides images for display at the AR device, an integrated cryptocurrency wallet, and/or other components. The AR device may generate an AR display, via one or more display devices, that is overlaid onto a physical environment.

The cryptocurrency wallet may include an application integrated with the AR system. For example, the cryptocurrency wallet may be executed from a physical storage device of the AR device and/or the AR processing unit. Access to the cryptocurrency wallet may be restricted to only an authorized user, as authenticated by the AR system. For example, the AR system may employ biometric authentication, password or PIN-based authentication, and/or other authentication techniques for authenticating authorized users of the cryptocurrency wallet. Because the cryptocurrency wallet uses a cryptocurrency recorded on the blockchain, third party payment and retail systems may not be required for purchases or fund transfers. Rather, the AR system may integrate payments through decentralized blockchain technology.

In operation, the AR processing unit may instantiate a draggable image for display on the AR device. The draggable image may represent an item for sale or a transfer of funds (e.g., a virtual check). For an item for sale, the draggable image may be associated with an identification of the item and/or other details of the item (such as a purchase price, a seller, etc.). For a transfer of funds, the draggable image may be associated with an identification of the transfer and/or other details of the transfer (such as a recipient, amount, etc.). The AR processing unit may instantiate an image that represents the integrated cryptocurrency wallet (“wallet image”). The AR device may detect a user input that indicates a dragging motion of the draggable image. The user input may include a hand gesture/motion and/or manipulation of the peripheral device. Coincident with the dragging, the AR device may move the draggable image across the AR display until the image intersects the wallet image in the AR display. Such intersection will cause the draggable image to be “dropped” into the wallet image either immediately or upon confirmation by the user. Upon dropping, the AR system may identify the item or transfer of funds based on the draggable image that was dropped. In some instances, the user may be prompted to approve the purchase and/or transfer once the draggable image is dropped to the wallet image.

Assuming the user has been authenticated to access the cryptocurrency wallet, the AR system may initiate a blockchain transaction in which an amount of cryptocurrency is transferred from the cryptocurrency wallet to the seller's cryptocurrency wallet in order to facilitate a purchase of the item. For example, the cryptocurrency wallet may generate a blockchain transaction that identifies the seller's cryptocurrency wallet. Cryptocurrency wallet may digitally sign the blockchain transaction with its private key.

The AR system may be similarly used to send and receive funds through drag and drop operations using an image of a cryptocurrency wallet in an AR display. For example, the AR system may display an image that represents funds sent to a recipient user. The image may be a virtual check in the AR display. The virtual check image may be dragged and dropped to the wallet image in the AR display. Doing so will initiate a transfer of the value of the check from the sender's cryptocurrency wallet to the user's cryptocurrency wallet. Other types of transfers may be initiated as well.

In some implementations, the wallet image may have different regions each associated with a different functionality. For instance, one region of the wallet image may be associated with a function to purchase an item (used by buyers), another region may be associated with a function to register an item for sale (used by sellers), another region may be associated with sending funds to another user (used by senders), and another region may be associated with confirming receipt of funds transferred from another user (used by recipients). If a user drops a draggable item to the region corresponding to purchasing an item, the AR system may initiate a purchase of the item. On the other hand, if the user drops a draggable item representing a fund transfer, the AR system may initiate a fund transfer. Alternatively, the AR system may automatically determine the function (e.g., purchase, register item, transfer funds) to be executed based on the draggable image that is dropped to the wallet image. More particularly, the AR system may automatically determine the function to be executed based on the item or fund transfer represented by the draggable image.

In some implementations, a seller may use the system to register items for sale by uploading or otherwise generating an image representing the item. For example, the system may configure an item for sale through a drag and drop operation in an AR display. An AR device may overlay in the AR display the wallet image onto a physical environment. The AR device may receive an image file uploaded from the seller or a link to a networked image for instantiation into the AR display. Alternatively, the AR device may image an item appearing in the physical environment of a seller, and the seller may indicate that the item is for sale by selecting the item in the AR display. The AR device may detect an image of an item was dragged and dropped to the wallet image in the AR display. For example, the seller may have dragged and dropped the image of the item to the wallet image in the AR display.

The AR device may prompt for and receive one or more item requirement parameters for selling the item. The one or more item requirement parameters may include a price, a quantity/amount, a description, and/or other information relating to the item. The AR device may add the item to a database of items in association with the seller's cryptocurrency wallet. For example, the item may be added as a record to an item database. The record may include an item identifier, which may uniquely identify the item uploaded by the seller, linked with the one or more item requirement parameters, the image of the item (for later presentation or matching), a seller ID, and/or other data. The Seller ID may be, for example, the Seller's public key associated with its wallet.

Various examples described herein will refer to a drag and drop operation. However, other types of gestures made in AR displays may initiate the various functionality described herein. For example, a long stare or other eye focus on an object may trigger the functionality of the drag and drop described herein. Furthermore, various examples will describe an AR implementation for convenience, although the functionality described herein may be applied to other electronic reality systems as well. For instance, in MR implementations, images generated by the system may be generated to appear to be part of the physical environment. For VR implementations, instead of associating images with the physical environment, the environment is completely virtual. Thus, images described herein mapped with the physical environment may be overlaid instead with other images generated by the system in a VR context.

It should be noted that although various implementations have been described with respect to AR (as well as MR and VR) implementations, the system may be implemented using two-dimensional displays such as Internet/Web-based displays via web browsers and/or other two-dimensional graphical user interfaces. For example, for web-based implementations, the seller may tag an item for sale and the system may provide the seller with an item identifier that the system recognizes. The seller may embed an image representing an item that is encoded with a Uniform Resource Locator (“URL”) that specifies an item identifier, seller identifier, and/or other information. For example, the URL may be encoded with the image in image metadata. The seller or others may publish the image representing the item with the encoded URL in a graphical user interface, such as a web site. A user's device may be programmed with an agent that receives the image and obtains the URL encoded by or otherwise associated with the image. In some instances, the agent may execute on a web browser of the user device and/or independent of the browser. In this way, the agent may generate and display a wallet image within or outside the browser window of the user device. The draggable image published on the website, for example, may be dragged to the image wallet within the browser or outside the browser in the native display environment of the user device.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example of a system for implementing AR displays that that integrates a cryptocurrency wallet with drag and drop functionality, according to an implementation of the invention.

FIG. 2 illustrates an example of a process of configuring an item for sale through a drag and drop operation in an AR display, according to an implementation of the invention.

FIG. 3A illustrates an example of an AR display for configuring a product for sale through a drag and drop operation in the AR display, according to an implementation of the invention.

FIG. 3B illustrates an example of an AR display for configuring a service for sale through a drag and drop operation in the AR display, according to an implementation of the invention.

FIG. 4 illustrates an example of a process of purchasing an item for sale through a drag and drop operation in an AR display, according to an implementation of the invention.

FIG. 5A illustrates an example of an AR display for purchasing a virtual item for sale through a drag and drop operation in the AR display, according to an implementation of the invention.

FIG. 5B illustrates an example of an AR display for purchasing a physical item for sale through a drag and drop operation in the AR display, according to an implementation of the invention.

FIG. 6 illustrates an example of a process of sending funds through a drag and drop operation in an AR display, according to an implementation of the invention.

FIG. 7 illustrates an example of a process of receiving funds through a drag and drop operation in an AR display, according to an implementation of the invention.

FIG. 8 illustrates an example of an AR display for depositing a transfer of funds based on a drag and drop operation in the AR display, according to an implementation of the invention.

FIG. 9 illustrates an example of an AR processing unit, according to an implementation of the invention.

FIG. 10 illustrates an example of an AR device, according to an implementation of the invention.

### DETAILED DESCRIPTION OF THE INVENTION

The disclosure relates to an improved electronic reality system (e.g., augmented reality, mixed reality, and/or or virtual reality system) that integrates a cryptocurrency wallet for transmitting funds between senders and recipients based on interactions made in the electronic reality system, such as a drag and drop interaction in which an image of an item to be purchased or representation of funds to be transferred is dragged and dropped to an image of the cryptocurrency wallet, according to an implementation of the invention.

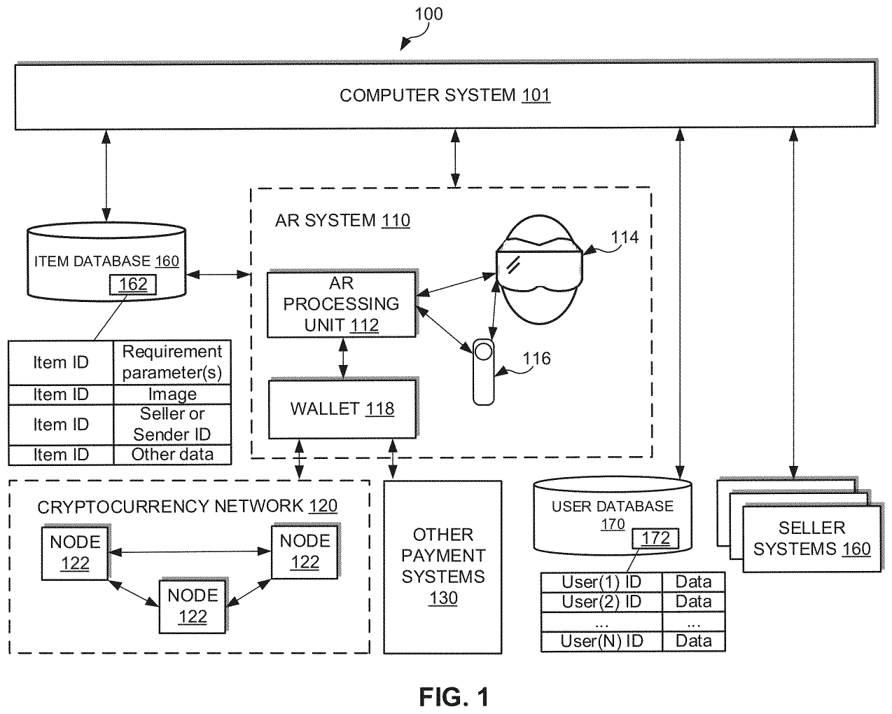

FIG. 1 illustrates an example of a system 100 for implementing AR displays that integrates a cryptocurrency wallet with drag and drop functionality, according to an implementation of the invention. The system 100 may include a computer system 101, an AR system 110, a cryptocurrency network 120 comprising multiple nodes 122, one or more retail systems 140, an item database 160, a user database 170, and/or other components.

The computer system 101 may register users to use the system 100. For instance, the computer system 101 may register retailers and other sellers, users who wish to make purchases or send or receive funds through the AR system 110, and/or others. Information such as a shipping address of the user and/or other information of the user may be stored by the computer system 101 such as in a user database 170. The computer system 101 may assign a user with a cryptocurrency wallet 118 (illustrated and also referred to as “wallet 104” for convenience). For instance, the computer system 101 may assign public and private keys used by the wallet 118 for blockchain transactions on the cryptocurrency network 120. The assigned public key may be used to identify the user in the user database 170. Other user identifiers may be used as well. In some implementations, the computer system 101 may provide wallet 116 for download to the AR system 110. In other implementations, the AR system 110 may be preconfigured with the wallet 118. The computer system may obtain or otherwise identify items for sale, mediate transactions, and populate the item database 160 and user database 170 with information described herein.

The AR system 110 may provide an AR display to a user with an integrated cryptocurrency wallet 118 for transferring funds based on drag and drop interactions made in the AR display through various components of the AR system. For example, the AR system 110 may include an AR processing unit 112, an AR device 114, a peripheral device 116, the cryptocurrency wallet 118, and/or other components.

The AR processing unit 112 may support the functionality of the AR device 114. For example, the AR processing unit 112 may be programmed to receive sensor signals from the AR device 114 to sense objects in a physical environment of the AR display device. The AR processing unit 112 may provide the AR device 114 with AR images that augment the physical environment. The AR device 114 may include one or more electronic displays, which may be stereoscopic displays for three-dimensional overlays onto the physical environment, that display the AR images. The AR device 114 is generally, though not necessarily, a head-mounted device. Other configurations may be used as well. The AR images may be in any electronic visual representation that can be located and moved within an electronic display for dragging and dropping interactions. For example, the AR images may include a photograph, video, logo, graphic, text, and/or other electronic visual format. The peripheral device 116 may be a generally handheld device controlled by the user for pointing, selecting, and/or other functionality to control the AR display.

The peripheral device 116 may include one or more sensors, emitters (such as light or radiofrequency emitters), and/or other devices for determining a location and orientation of the peripheral device 116. The AR processing unit 112 may determine the location and/or orientation of the peripheral device 116 based on sensor information from the sensors and/or emissions from the emitters to determine where the user is pointing the peripheral device 116 within the AR display. As such, the peripheral device 116 may be used to drag and drop AR images displayed in the AR display. Alternatively or additionally, a human hand may be sensed by the sensors of the AR device 114 for drag and drop and other interactions in the AR display.

Securing the Cryptocurrency Wallet in an AR Display

In some implementations, the AR system 110 may secure the wallet 118 based on credentialed access. For example, the AR system 110 may use biometric credentials, password or Personal Identification Numbers, and/or other security techniques to secure the wallet 118. In particular, access to the functionality of the wallet 118, such as creating blockchain transactions having payloads that specify a transfer of cryptocurrency, may be restricted and granted only when appropriate credentials are provided. In this manner, only authorized users of the AR system 110 may be provided with access to the integrated wallet 118.

Various cryptocurrencies and corresponding type of wallet 118 may be used. For instance, the crypto-token described in U.S. Provisional Patent Application No. 62/728,212, entitled, “Stable Cryptocurrency Using Decentralized Dual Reserve”, filed on Sep. 7, 2018, the contents of which are incorporated by reference in its entirety herein, may be used. The foregoing application describes a cryptocurrency that has a stable purchasing power over time. Other types of cryptocurrencies, such as Bitcoin or Ether, may be used as well.

Displaying the Cryptocurrency Wallet in an AR Display

The AR device 114 may provide an option to display an image representing the cryptocurrency wallet 118. Selection of the option (such as by pointing with a finger and/or with the peripheral device 116) may cause the AR device 114 to generate an image representing the cryptocurrency wallet 118 (also referred to as “wallet image” for convenience). The wallet image may be displayed in the AR display so that other images in the AR display may be dragged and dropped to it. The wallet image may include different parts that are mapped to different functions. For example, one portion of the wallet image may be designated for registering items for sale, another portion for purchasing an item, and another portion for sending or receiving funds. In this way, an item dragged to designated portions of the wallet image will set the context for actions the AR device 114 will take. For example, an image of an item dragged and dropped to the portion designated for purchasing the item will cause the AR device 114 to initiate a transaction to purchase the item.

Alternatively or additionally, the AR device 114 may provide a graphical menu overlay in the AR display. This menu may include selectable options for registering an item for sale, making a purchase, transferring funds, and/or other functionality described herein. Selection of one of these selectable options (such as by pointing with a finger and/or with the peripheral device 116) may cause the AR device 114 to generate an image representing the cryptocurrency wallet 118. Depending on the other image and/or context based on the selectable option, the AR system 110 may initiate an item registration, a purchase, a fund transfer, and/or other activity to occur.

Various users, such as senders, recipients, sellers, and others may use the AR system 110 to buy items, sell items, set up items for sale, send funds, receive funds, and/or otherwise use the cryptocurrency wallet 118 to generate blockchain transactions based on interactions in the AR display.

Registering Items for Sale

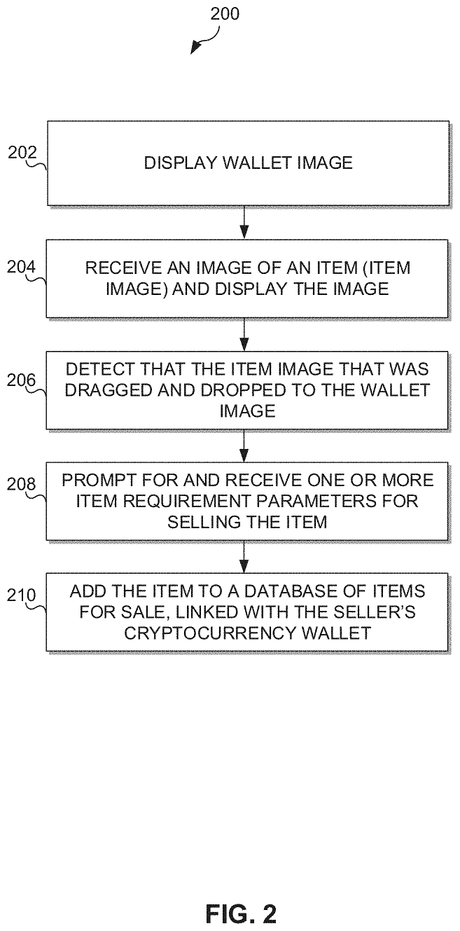

In some implementations, a seller may use the AR system 110 to register items for sale by uploading or otherwise generating an image representing the item. For example, FIG. 2 illustrates an example of a process 200 of configuring an item for sale through a drag and drop operation in an AR display, according to an implementation of the invention.

In an operation 202, process 200 may include displaying a wallet image in the AR display. For example, the AR device 114 may overlay the wallet image onto a physical environment.

In an operation 204, process 200 may include receiving an image of an item for sale. For example, the AR device 114 may receive an image file uploaded from the seller or a link to a networked image for instantiation into the AR display. Alternatively, the AR device 114 may image an item appearing in the physical environment of a seller, and the seller may indicate that the item is for sale by selecting the item in the AR display.

In an operation 206, process 200 may include detecting an image of an item was dragged and dropped to the wallet image in the AR display. For example, the seller may have dragged and dropped the image of the item to the wallet image in the AR display.

In an operation 208, process 200 may include prompting for and receiving one or more item requirement parameters for selling the item. The one or more item requirement parameters may include a price, a quantity/amount, a description, and/or other information relating to the item.

In an operation 210, process 200 may include adding the item to a database of items in association with the seller's cryptocurrency wallet. For example, the item may be added to the item database 160 as a record 162. The record 162 may include an item identifier, which may uniquely identify the item uploaded by the seller, linked with the one or more item requirement parameters, the image of the item (for later presentation or matching), a seller ID, and/or other data. The Seller ID may be, for example, the Seller's public key associated with its wallet 14.

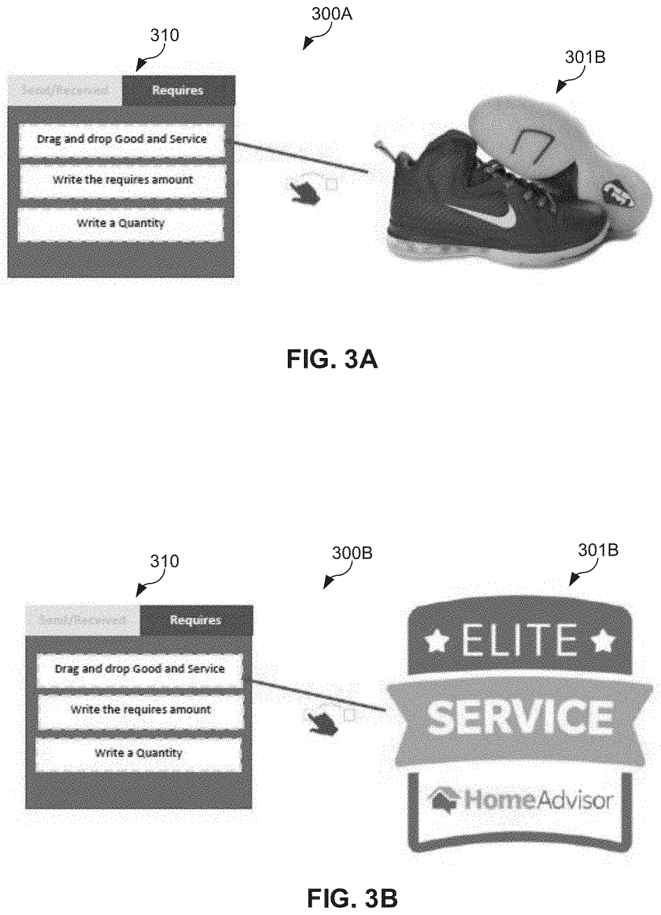

FIG. 3A illustrates an example of an AR display 300A for configuring a product for sale through a drag and drop operation in the AR display, according to an implementation of the invention. An image 301A representing an item and a wallet image 310 may be displayed in the AR display 300A. A user may select a “Requires” section of the wallet image 310 and/or may drag and drop the image 301A into the “Requires” section of the wallet image 310. Upon dragging and dropping the image 301A into the wallet image 310 in the AR display 300A, the AR display device 116 may obtain item requirement parameters for the product.

FIG. 3B illustrates an example of an AR display 300B for configuring a service for sale through a drag and drop operation in the AR display, according to an implementation of the invention. An image 301B representing a service and a wallet image 310 may be displayed in the AR display 300B. A user may select a “Requires” section of the wallet image 310 and/or may drag and drop the image 301B into the “Requires” section of the wallet image 310. Upon dragging and dropping the image 301B into the wallet image 310 in the AR display 300A, the AR display device 116 may obtain item requirement parameters for the service.

It should be noted that instead of or in addition to the item registration process illustrated by FIGS. 2, 3A, and 3B, sellers may register items in batches. For example, seller systems 140, which may represent the computer infrastructure of online retailers, may upload items for sale to the item database 160. In some instances, these sellers may provide applications for execution by the AR system 110 that represent storefronts that can augment the physical environment (or be represented in a virtual reality environment). Alternatively, these items may be matched with physical items in the physical environment to provide a user with an option to purchase the item recognized in the physical environment (or purchase an item that is similar to the recognized item).

The AR device 114 may display, in the AR display, an image that represents an item (such as a product or service) for sale, an amount to be transferred from a sending user to a recipient user, and/or other thing that can be dragged and dropped to an image of a cryptocurrency wallet. The AR device 114 may display, in the AR display, a second image that represents the cryptocurrency wallet 104 of the user. The cryptocurrency wallet 104 may be associated with a balance of a cryptocurrency held by the user that may be transferred to others via blockchain transactions validated through the nodes 122 of the cryptocurrency network 120, and immutably stored on a blockchain of the cryptocurrency network.

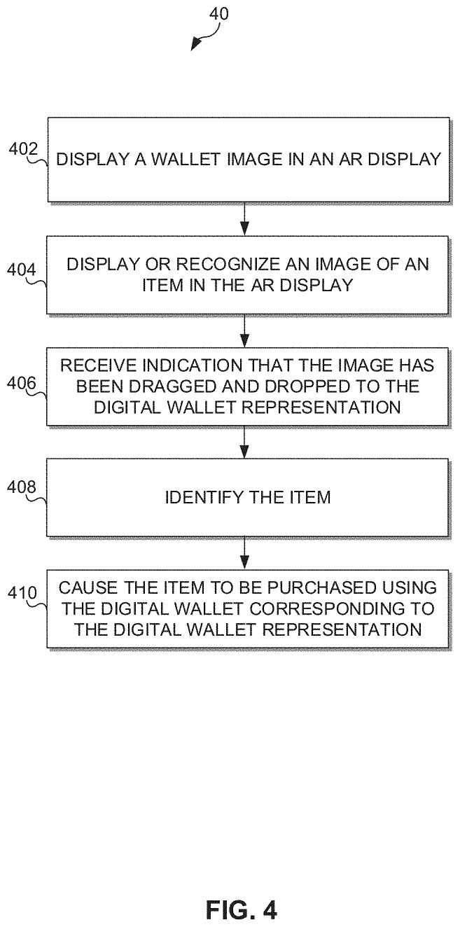

FIG. 4 illustrates an example of a process 400 of purchasing an item for sale through a drag and drop operation in an AR display, according to an implementation of the invention.

In an operation 402, process 400 may include displaying a wallet image in the AR display. For example, the AR device 114 may overlay the wallet image onto a physical environment.

In an operation 404, process 400 may include displaying or recognizing an image of an item for sale in the AR display. For example, in retail location recognition, the AR device 114 may determine that the physical environment is a retail location of a seller (or a store of a retailer that sells products similar to those of a seller). This may be based on input from a user and/or automatic location recognition/detection using onboard location sensors and/or image recognition of the physical environment. The AR device 114 may accordingly present one or more images of items for sale by the seller. Alternatively or additionally, the AR system 110 may perform image recognition on physical items imaged from the physical environment, and match the image of the physical item with images of items for sale in the item database 160. Matching images may be provided for viewing in the AR display. Whether based on retail location recognition and/or image recognition of physical items, the user may drag and drop the item image to the wallet image in an operation 406.

In an operation 408, process 400 may include identifying the item that was dragged and dropped to the wallet image. For example, the AR system 110 may tag the item image with an item ID, which is associated with metadata from the item database 160. It should be noted that the image may be tagged with an image identifier, which may be associated with metadata from the item database 160. The AR system 110 may obtain the item ID based on the dragged and dropped image, and lookup the seller (e.g., the seller's wallet 118), the item, the price, and/or other information needed to complete the sale.

In an operation 410, process 400 may include causing the item to be purchased using the user's wallet 118, which corresponds to the wallet image. In some instances, for example, the AR system 110 may generate a blockchain transaction that transfers the price in cryptocurrency from the user's wallet 118 to the seller's wallet 118. Other types of transactions such as credit card or other fiat-currency based transactions may be used as well.

Virtual Item Purchases

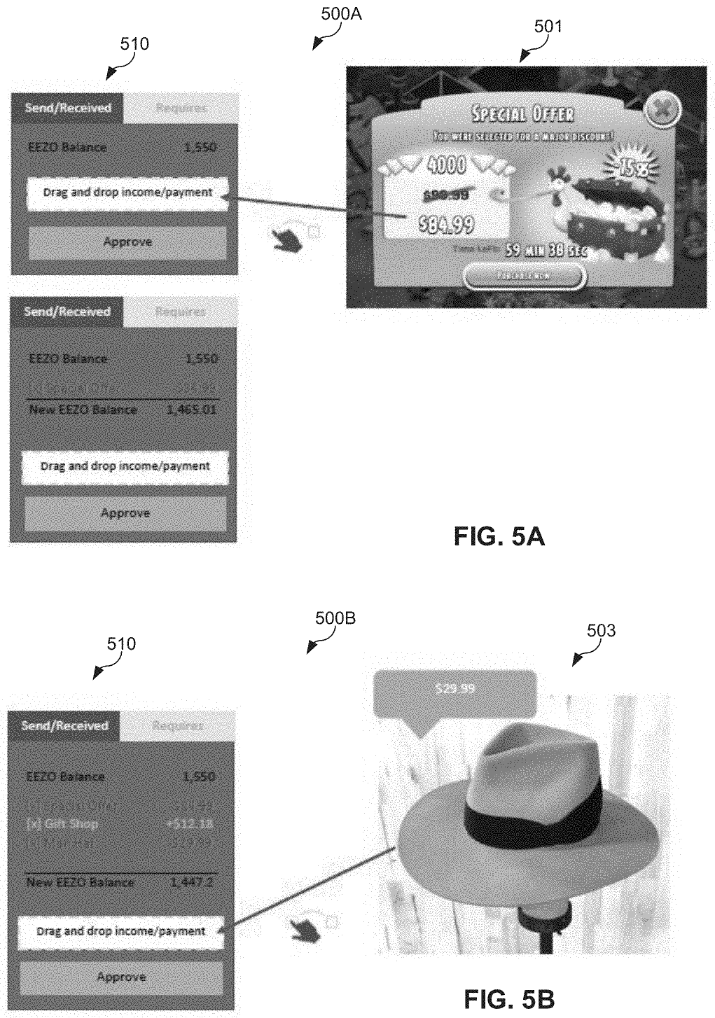

FIG. 5A illustrates an example of an AR display 501A for purchasing a virtual item for sale through a drag and drop operation in the AR display, according to an implementation of the invention. An image 501 representing a virtual item and a wallet image 510 may be displayed in the AR display 500A. A user may drag and drop the image 501 to the wallet image 310. For example, the wallet image 310 may have a section “Drag and drop income/payment” for dragging and dropping images of items to be purchased. Upon dragging and dropping the image 501 into the wallet image 510 (such as at the section for dragging and dropping images) in the AR display 500A, the AR display device 116 may obtain add the virtual item to a queue of items in the user's wallet 118 corresponding to the wallet image 510. In this example, the wallet image 510 may serve as an electronic shopping cart that tallies items being purchased and their associated debits to be made from the wallet 118. For example, the price of the virtual item represented by the dragged and dropped image 501 may be added to the electronic shopping cart. The wallet image 510 may include an “Approve” display option for approving the transactions in the electronic shopping cart. Upon selection of the Approve display option, the AR system 110 may cause the items to be purchased (and corresponding debit from the wallet 118 and credit to a seller wallet 118).

For virtual items used in the AR system 110, the purchased virtual items may be made available for use immediately in the AR display 501. For example, if the virtual item was purchased in association with a game being played, the virtual item may be made available to the user for gameplay immediately upon transaction verification. If the virtual item relates to digital media, the appropriate digital media file may be made available for streaming or downloading immediately upon transaction verification. Other types of virtual item delivery may be made available as well.

Physical Item Purchases

FIG. 5B illustrates an example of an AR display 501B for purchasing a physical item for sale through a drag and drop operation in the AR display, according to an implementation of the invention. An image 503 representing a physical item and a wallet image 510 may be displayed in the AR display 500B. To do so, the AR device 114 may recognize a physical item in the physical environment and generate the image 503 corresponding to the physical item. This image 503 may be draggable and droppable to the wallet image 510. To recognize the physical item, the AR device 114 may perform image recognition and/or scan an item code such as a Universal Product Code. In other instances, the AR device 114 may receive an input from the user that identifies the physical item.

A user may drag and drop the image 503 to the wallet image 510. Upon dragging and dropping the image 503 into the wallet image 510 (such as at the section for dragging and dropping images) in the AR display 500A, the AR display device 116 may obtain add the physical item to a queue of items in the user's wallet 118 corresponding to the wallet image 510. In this example, the wallet image 510 may serve as an electronic shopping cart that tallies items being purchased and their associated debits to be made from the wallet 118. For example, the price of the physical item represented by the dragged and dropped image 501 may be added to the electronic shopping cart. The wallet image 510 may include an “Approve” display option for approving the transactions in the electronic shopping cart. Upon selection of the Approve display option, the AR system 110 may cause the items to be purchased (and corresponding debit from the wallet 118 and credit to a seller wallet 118).

If the user is not at a physical store, the item may be purchased and shipped to an address of the user, which may be stored in association with the user's wallet 118. In this manner, actual physical products purchased by the user using the AR system 110 may be delivered to the user's address. For example, the transaction may be provided to the seller system 140, which may process the sale. Alternatively, the physical products purchased by the user using the AR system 110 may be set for pick up by at a seller location.

Sending Funds Via AR Drag and Drop with the Integrated Wallet

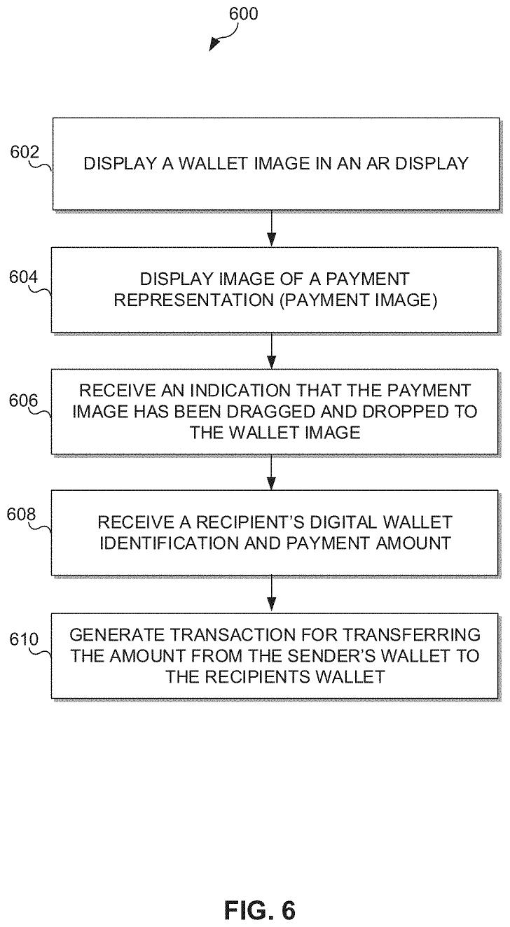

FIG. 6 illustrates an example of a process 600 of sending funds through a drag and drop operation in an AR display, according to an implementation of the invention.

In an operation 602, process 600 may include displaying a wallet image in the AR display. For example, the AR device 114 may overlay the wallet image onto a physical environment. The wallet image may correspond to a wallet 118 of a user that is sending funds, such as to another user's wallet 118.

In an operation 604, process 600 may include displaying an image of a payment representation (also referred to as a “payment image” for convenience). The AR device 114 may display the payment image on the AR display upon activation by the user of a payment option or other triggering event (such as a reminder to pay another user, a recurring payment, etc.). The user may drag and drop the payment image to the wallet image in the AR display.

In an operation 606, process 600 may include receiving an indication that the payment image has been dragged and dropped to the wallet image.

In an operation 608, process 600 may include receiving details of the transfer, such as the sender's identification (which may be a public key of the sender's wallet 118), recipient's identification (which may be a public key of the recipient's wallet 118), an amount of the transfer, a date for the transfer, and/or other information relating to the transfer. In some instances, the AR device 114 may require credentials of the sending user to access the wallet 118 and/or confirmation of the transfer. In some instances, process 600 may include generating a record in the item database 160 for the transfer. For instance, the transfer may be assigned with an item identifier, which is associated with the payment image, amount, sender ID (which may be the public key of the sender's wallet 118), recipient ID (which may be the public key of the recipient's wallet 118), and/or other information relating to the transfer.

In an operation 610, process 600 may include generating a blockchain transaction transferring the amount to the recipient (such as the public key of the recipient's wallet 118), which may include digitally signing the blockchain transaction with the private key associated with the sender's wallet 118. In some instances, instead of generating the blockchain transaction immediately, operation 610 may include notifying the recipient of the transfer and waiting for acknowledgement from the recipient. For example, the AR system 110 may communicate the indication of the transfer to the computer system 101, which may identify the AR system 110 used by the recipient based on the recipient's ID (the computer system 101 is aware of the public key of the recipient's wallet 118 as determined when that user was registered to use the system). The computer system 110 may provide a notification to the recipient user's AR system 110. When the recipient acknowledges and accepts the transfer, operation 610 may generate the blockchain transaction for validation at the nodes 122, and subsequent recordation on the blockchain.

Receiving Funds Via AR Drag and Drop with the Integrated Wallet

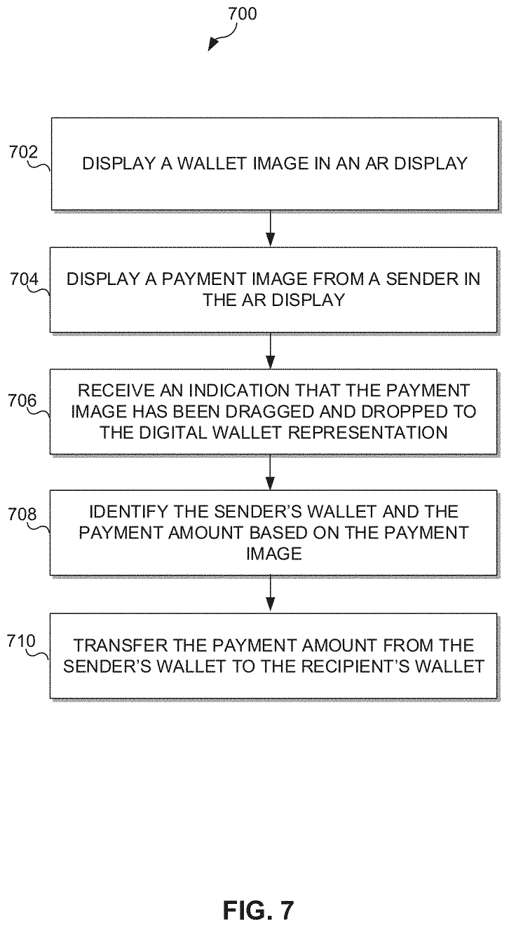

FIG. 7 illustrates an example of a process 700 of receiving funds through a drag and drop operation in an AR display, according to an implementation of the invention.

In an operation 702, process 700 may include displaying a wallet image in the AR display. For example, the AR device 114 may overlay the wallet image onto a physical environment. The wallet image may correspond to a wallet 118 of a user that is receiving funds send from another user, such as a sending user's wallet 118 (as described with respect to process 600). In some instances, the wallet image may be displayed in response to receiving a notification that the transfer has been initiated from the sender.

In an operation 704, process 700 may include displaying the payment image from the sender in the AR display of the recipient's AR device 114. For example, the image stored in the item database 160 corresponding to the transfer may be obtained and displayed in the AR display of the recipient. Alternatively, a generic template image may be used.

In an operation 706, process 700 may include receiving an indication that the payment image has been dragged and dropped to the wallet image.

In an operation 708, process 700 may include identifying the payment details, such as the sender identifier and the payment amount.

In an operation 710, process 700 may include transferring the payment amount from the sender's wallet to the recipient's wallet.

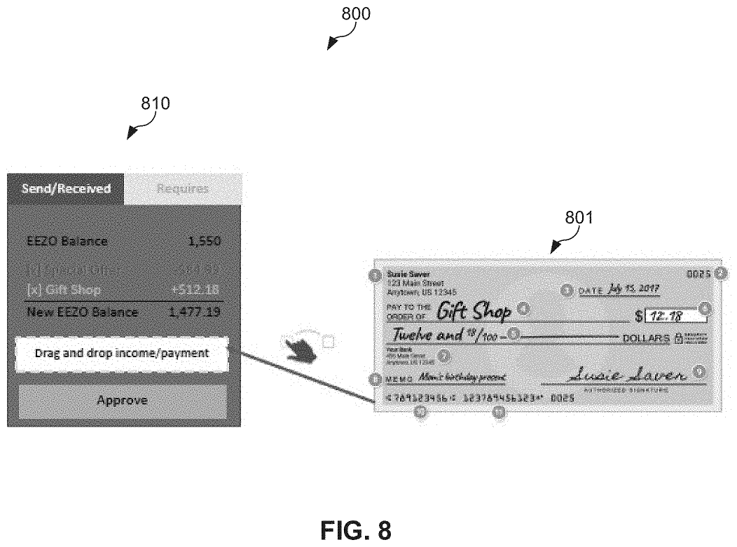

FIG. 8 illustrates an example of an AR display 800 for depositing a transfer of funds based on a drag and drop operation in the AR display 800, according to an implementation of the invention. The AR display 800 of a recipient may display a payment image 801 in the AR display. The AR display may display a wallet image 810. The user may drag and drop the payment image 801 to the wallet image 810. The wallet image 810 may serve as a shopping cart indicator that shows debits (e.g., for purchases and transfer to others) and credits (e.g., for returns or incoming transfers). Upon selection of the Approve display option, the AR device 114 may initiate transfers to and from the wallet 118 corresponding to the wallet image. For example, the AR device 114 may provide an indication to initiate the transfers to the AR processing unit 112, which may instruct the integrated wallet 118 to generate the appropriate blockchain transactions. For example, for each debit and credit displayed in the wallet image 810, the wallet 118 may generate a blockchain transaction to transfer out the appropriate amounts and/or acknowledge receipt of incoming transfers.

It should be noted that although various implementations have been described with respect to AR (as well as MR and VR) implementations, the system 100 may be implemented using two-dimensional displays such as Internet/Web-based displays via web browsers and/or other two-dimensional graphical user interfaces. For example, for web-based implementations, the seller may tag an item for sale and the system may provide the seller with an item identifier that the system recognizes. The seller may embed an image representing an item that is encoded with a Uniform Resource Locator (“URL”) that specifies an item identifier, seller identifier, and/or other information. For example, the URL may be encoded with the image in image metadata. The seller or others may publish the image representing the item with the encoded URL in a graphical user interface, such as a web site. A user's device may be programmed with an agent that receives the image and obtains the URL encoded by or otherwise associated with the image. In some instances, the agent may execute on a web browser of the user device and/or independent of the browser. In this way, the agent may generate and display a wallet image within or outside the browser window of the user device. The draggable image published on the website, for example, may be dragged to the image wallet within the browser or outside the browser in the native display environment of the user device.

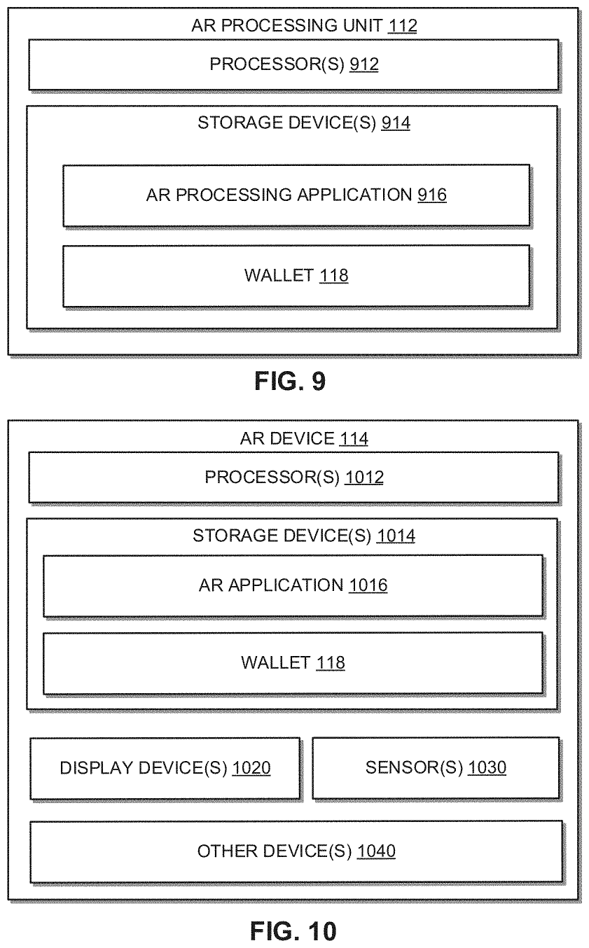

FIG. 9 illustrates an example of an AR processing unit 112, according to an implementation of the invention. The AR processing unit 112 may include one or more physical processors 912, one or more storage devices 914, and/or other components such as networking components for communicating with the computer system 110, the AR device 114, the peripheral device 116, and/or other components of system 100. The one or more physical processors 912 may be programmed with computer program instructions, which may be stored in the one or more storage devices 914. For example, the one or more physical processors 912 may be programmed with an AR processing application 916. The AR processing application 916 may generate overlays onto the physical environment (for AR/MR implementations) or generate the virtual world environment (for VR implementations). The AR processing application 916 may map the physical environment to an AR space (or vice versa) using conventional AR techniques to generate an AR environment.

For example, the AR environment displayed via the display of the AR device 114 may include a physical space and the AR space. In some embodiments, the physical space may be imaged by an imaging device of the AR device 114 and displayed via the AR display. In some embodiments, the physical space may simply be viewed through the AR display, such as in embodiments where the display is configured as an at least partially transparent display (e.g., a lens) through which the physical space may be viewed. Whichever embodiment to display the physical space is used, one or more draggable images may be displayed in the AR display. These draggable images may, in some instances, be coincident with or displayed in association with one or more physical objects in the physical environment.

In some implementations, the AR processing application 916 may include an event handler configured to detect whether an event occurs in the AR environment. The event handler may receive data from an imaging device of the AR device 114.

In some implementations, the event handler may receive visual data from the imaging device, information relating to draggable images or wallet images displayed by the AR device 114, and/or other information related to the AR environment. The event handler may compare the received information to data related to events stored in the storage to determine whether the information (or a portion of the information) is associated with an event. When the received information is associated with an event, the event handler may transmit event data including the received information and data relating to the associated event. These events may include a draggable image being dragged, the draggable image intersecting with a wallet image, a draggable image being dropped to a wallet image (and a location or region of the wallet image it was dropped), and/or other events occurring in the AR environment.

It should be noted that some or all of the functions described with respect to the AR processing unit 112 may be performed at computer system 101.

FIG. 10 illustrates an example of an AR device 114, according to an implementation of the invention. The AR device 114 may include one or more physical processors 1012, one or more storage devices 1014, a display device 1020, one or more sensors 1030, and/or other devices 1040. The one or more physical processors 1012 may be programmed with computer program instructions, which may be stored in the one or more storage devices 1014. For example, the one or more physical processors 1012 may be programmed with an AR application 1016. The AR application 1016 may provide images for display through the display device 1020. The AR application 1016 may receive information from the AR processing unit 112 for rendering the images. The display device 1020 may display visual images. In AR implementations, the display device 1020 is enables a user to see through the display so that images displayed thereon may be overlaid onto a physical (real-world) environment. The one or more sensors 1030 may include imaging devices such as cameras, orientation devices such as gyroscopes, location devices such as onboard GPS sensors, accelerometers, and/or other devices configured to sense an orientation and/or location of the AR device 114.

The AR processing unit 112 may include an off-board device separate from and in communication with the AR device 114. For example, the AR processing unit 112 may include a server device that is connected to the AR device 114 via a Wide Area Network such as the Internet. In some instances, the AR processing unit 112 may include a portable device such as a mobile phone, tablet device, or laptop computer device that connects to the AR display device via a Local Area Network or short range network such as a Bluetooth connection. Alternatively or additionally, the AR processing unit 112 may be integrated with the AR device 114. In these instances, the AR processing unit 112 and the AR device 114 may share processing and storage hardware or may each have dedicated hardware and software that communicate over an internal communication bus.

The AR processing unit 112, AR device 114, and peripheral device 116 may collectively include various AR/MR devices such as those including the Microsoft HoloLens, Magic Leap and the Meta 2 for AR/MR implementations and various VR devices such as those including the Oculus Rift, HTC Vive, PlayStation VR, Gear VR and Google Cardboard for VR implementations.

Although not expressly illustrated in FIG. 1, the computer system 110 may include one or more physical processors that are programmed by computer program instructions, which may be stored in a physical storage device. The various instructions described herein are by example only. Other configurations and numbers of instructions may be used, so long as the various processor(s) are programmed to perform the functions described herein.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, node 122 may be programmed by one or more additional instructions that may perform some or all of the functionality attributed herein to one of the instructions.

The various instructions described herein may be stored in a storage device of a device, which may comprise random access memory (RAM), read only memory (ROM), and/or other memory. The storage device may store the computer program instructions (e.g., the aforementioned instructions) to be executed by the processors as well as data that may be manipulated by the processors. The storage device may comprise floppy disks, hard disks, optical disks, tapes, or other storage media for storing computer-executable instructions and/or data.

One or more databases may be used by, for example, system components outside the blockchain. The databases described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

Each node 122 may include one or more processors programmed by instructions stored at one or more storage devices. The storage device may store a decentralized ledger (e.g., a blockchain) that records multiple blocks that each include a payload of one or more blockchain transactions. Each block may be identified by a hash and may refer to a prior block's hash.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in the figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Although described herein as an improved technology for stabilizing the value of a cryptocurrency, the systems and methods may be used to stabilize other types of electronic units of value that are not centrally managed by, for example, a central bank.

Other implementations, uses and advantages of the invention will be apparent to those skilled in the art from consideration of the specification and practice of the invention disclosed herein.

What is claimed is:

1. A computer implemented electronic reality system for transmitting funds via a cryptocurrency wallet based on interaction with an image of an item to be purchased and/or an image of funds to be transferred for the purchase and a cryptocurrency wallet, the system comprising computer code for execution on a computer processor, wherein the code is configured when executed to:
display an image of at least one of an electronic representation of an item to be purchased, a representation of funds, and cryptocurrency wallet;
detect a user selection of at least one of the images and an interaction of that image with a second one of the images;
initiate a blockchain transaction involving the selected images.

2. The system of claim 1, where the first image is an item to be purchased and the second image is a representation of a crypto currency wallet to provide funds for the purchase, and the interaction comprises dropping an image of the item to be purchased on the crypto currency wallet, and the transaction is a purchase of the item using funds from the crypto currency wallet.

3. The system of claim 1, where the first image is an item representing funds to be transferred and the second image is a representation of a crypto currency wallet from which the funds are to be transferred and the interaction comprises dropping an image of the funds to be transferred on the crypto currency wallet, and the transaction is a transfer of the funds from the crypto currency wallet to a recipient crypto currency wallet.

4. The system of claim 1, wherein the electronic reality system comprises an augmented reality (AR) system, a virtual reality (VR) system or a mixed reality (MR) system and the images comprise AR objects, VR objects and/or MR objects.
